(19) United States
(12) Patent Application Publication
(10) Pub. No.: US 2012/0256430 A1
(43) Pub. Date: Oct. 11, 2012

(54) Electrically-operated animal excrement collector

(76) Inventor: Jesús Merino-García, Sedan (ES)

(21) Appl. No.: 13/507,150

(22) Filed: Jun. 9, 2012

Related U.S. Application Data
(63) Continuation-in-part of application No. 12/452,920, filed on Jan. 27, 2010.

(30) Foreign Application Priority Data
Aug. 30, 2007 (ES) U200701810

(51) Int. Cl. A01K 29/00

(52) U.S. Cl. 294/1.3

(57) ABSTRACT

An electrically-operated animal excrement collector including an external housing having inside an electrically coupled motor, rechargeable battery and a switch and a collection system engages to the electrical motor via a worm gear. Once the motor is activated the worm gear transmits an up and down lineal movement to the collecting system. The collecting system includes multiple collecting elements simulating claws, which once a bag is inserted at the lower section of the device and the device is activated are able to pick up, store the excrements inside the bag. Optionally, the device may include other elements such as lights, a retractable leash a cylindrical base and a separator unit.

This application is a continuation-in-part of non-provisional application Ser. No. 12/452,920, filed Jan. 27, 2010, now spending, which is the National Stage of International Application No. PCT/ES2008/000256 filed Apr. 16, 2008, which claim priority to Spain Application No. U200701810, filed Aug. 30, 2007. Each patent application identified above is incorporated here by reference in its entirety to provide continuity of disclosure.

### FIELD OF THE INVENTION

The invention relates to a device useful in the collection and disposal of animal excrements. More particularly, the instant invention is directed to an electrically operated device use in picking up, storing and disposing of animal excrements.

### BACKGROUND OF THE INVENTION

Around the worlds, millions of people are pet or animal owners. The advantages of having a pet are well known. Nonetheless, with such conveniences provided by the pet, the owner must satisfy different social responsibilities besides the basic care taking duties directed to the wellbeing of the animal or pet.

One of such responsibilities is collecting the animal excrements while walking the animal, particularly in public places, such as streets, parks and other public thoroughfares. Collecting and properly disposing said excrements are important measures directed to avoid public health problems to the general public as well as to pets. Collecting such excrements, however, is a non-pleasant action to the pet owner, due to the very nature of the process itself, wherein the pet owner must be in direct contact with the excrements, even when using a bag to cover his or her hand during said process. The alternative of not collecting such excrements in public places results in passing the problem to the government authorities and for that reason in many jurisdictions the lack of interest of pet owners in collecting such excrements has resulted in a punitive approach to such antisocial behaviour by criminalizing it and/or prohibiting said conduct.

Thus, there is a need to properly and hygienically collect and dispose animal or pet excrements, particularly when walking pets along pavements, parks, gardens and other similar public areas. It is highly desirable to provide a device that is useful in hygienically collecting and properly disposing such pet or animal excrements in public or any other areas.

### SUMMARY OF THE INVENTION

It is an object of the instant invention to provide a device useful in collecting and further disposing animal excrements in a hygienic and socially responsible manner. Another object of the invention is to provide a device that is easy to use and handle by any pet owner in the collection of excrement process. It is another object of the invention to provide a device that once used by pet owners to collect their pet's excrement, promote clean and hygienic public environments. Yet another object of the invention is to provide a device that is useful in the collection of animal excrement and simultaneously provided lighting fixture and animal control leash in order to facilitate a responsible pet walk in public places even during night hours or in dark places. In yet another object of the invention is to drastically reduce the cost of maintaining public areas clean by providing to pet owners an economical, lightweight, easy-to-use, healthy and fast manner to collect and properly disposed animal or pets excrements. In even yet another objective of the invention is to provide a personal or individual excrement collecting device, which is easy to transport, to clean, to use and to handle by pet's owner of any age.

These and other objectives have been achieved in accordance with the instant invention by providing an electrically operated device, highly convenient and effective in collecting, storing and disposing animal excrements without the need of the pet owner to be in direct contact with said excrements and in a very fast manner. Sad device provides a lightweight housing comprising an electric operated collecting system, which is engaged to a worm gear. The device also comprises a rechargeable battery, an electric motor and a dual control switch of easy access. By using the herein disclosed device, a pet owner may automatically collect excrements of pets in a bag after the collecting system of the device is activated and may store said excrements by a convenient short time, if desirable, and further properly and responsibly dispose them.

### BRIEF DESCRIPTION OF THE DRAWINGS

The nature and objects of the present invention and its advantages will be more clearly and easily understood after reading the following non-restricted description of preferred embodiments thereof, made with reference to the following drawings, in which:

FIGS. 1A and 1B are perspective views of a first embodiment of the invention. In FIG. 1A, the grasping elements are in close position while in FIG. 1B, the grasping elements are in open position.

FIG. 2 is a front view showing the details of housing elements of the embodiment illustrated in FIGS. 1A and 1B.

FIG. 3 shows a front view of the embodiment illustrated in FIGS. 1A and 1B, wherein the external housing has been omitted in order to illustrate the internal components of the embodiment and its integration at the interior of the device.

FIGS. 4A and 4B illustrates perspective views of a second embodiment of the invention, in FIG. 4A grasping elements are in close position while in FIG. 4B grasping elements are in open position.

FIG. 5A and FIG. 5 B illustrate front views of the external housing elements of the second embodiment of the invention illustrated in FIGS. 4A and 4B.

FIGS. 6A and 6B illustrate front views of the second embodiment of the invention, wherein the external housing has been omitted in order to show the internal components of the invention and its integration at the interior of the device. In FIG. 6A, the grasping elements are in a close position while in FIG. 6B the grasping elements are in an open position.

FIG. 6C illustrates a front view of a modification of the second embodiment, wherein the external housing has been excluded in order to show the internal parts of the invention, in this variation of the second modality, an internal compartment between the battery and the motor is included and illustrated in an exploded view.

FIG. 7 illustrates an exploded view of main parts of the second embodiment of the invention, separately.

FIG. 8 illustrates an example of required the battery used in the embodiments of the invention.

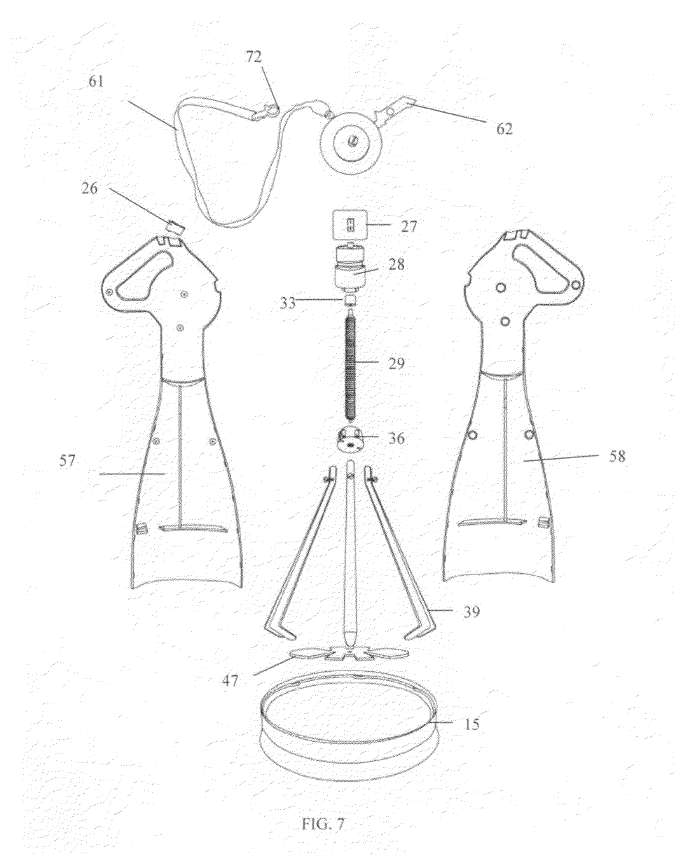

FIG. 9 illustrates an example of a motor used in the embodiments of the invention.

FIG. 10 illustrates an example of the worm gear used in the embodiment of the invention.

FIG. 11 illustrates a grasping elements holder having a cylindrical main body and a threaded hole at substantially its center, said cylindrical body being one of the elements of the grasping system of the embodiments of the invention.

FIGS. 12A and 12 B illustrates the integration of the grasping element holder, the grasping elements and the cylindrical base used in the embodiments of the invention.

FIG. 13 and FIG. 14 illustrate different views of the grasping elements already assembled to the grasping holder and cylindrical base.

FIG. 15 illustrates grasping elements assembled only to the grasping elements holder.

FIGS. 16A and 16B illustrate different views of the cylindrical base.

FIG. 17 illustrates a separator unit, useful as an option to maintain the grasping elements separated.

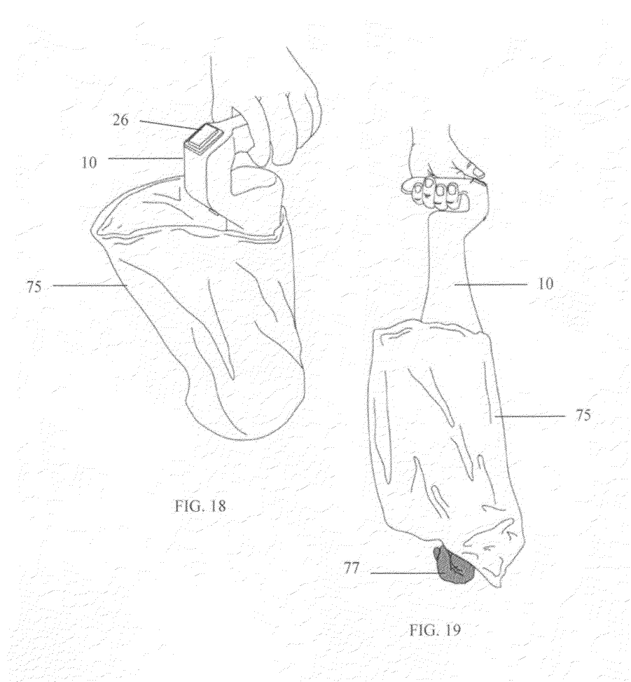

FIGS. 18-21 illustrate the used of the invention in collecting, storing and disposing animal or pet excrements.

### DESCRIPTION OF THE PREFERRED EMBODIMENTS

The present invention will now be described more fully hereinafter with reference to the accompanying drawing, in which preferred embodiments of the invention are illustrated. The invention may, however, be embodied in very different forms and should not be construed as limited to the embodiments set forth herein.

Rather, these embodiments are provided as examples and should not be interpreted as limiting since such embodiments are presented as a basis for the claims and with the main objective of teaching those skilled in the art to make and use the invention, in a manner that, this application will be thorough and complete, and will fully convey the true scope of the invention to those skilled in the art.

This invention is an easy-to-use, fast and very useful device that may be used to collect, store and properly dispose animal's excrement anywhere, but more particularly while walking pets on public places such as streets and parks. The instant invention comprises a device useful in picking up or collecting, momentarily storing and/or further dispose animal excrements. Said device comprises a grasping system that is electrically activated, thus providing a manner of collect, storing and further dispose animal excrements. Thus the use of the device facilitates the entire disposal process of animal excrements without the need of the pet owner to directly or physically contact said excrements, providing a hygienic and healthy method of collecting and disposing animal waste. Optionally, it may include an extendable and retractable leash to restrain the pet during walks and may also contain a lighting unit or fixture to illuminate dark areas while walking the pet.

The invention is herein presented in two embodiments having in common a series of elements and having different shapes and additional optional elements explained below in more details. Nonetheless, main electrical and mechanical internal components such as battery, motor, worm gear as well as the grasping system are essentially identical in function and design in each one of the herein disclosed embodiments.

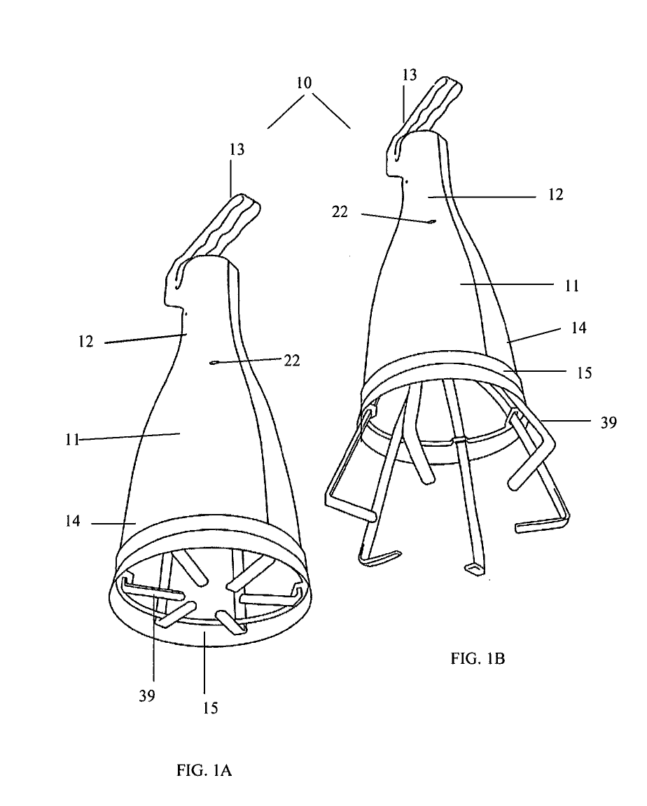

In reference to the drawings, FIGS. 1A and 1B show perspective views of embodiment 10. Said embodiment has a bell-shaped ergonomic body or housing 11 with a bottom section 14 having a diameter wider that the upper section 12, a handle 13 at the upper section of said bell-shaped body 11.

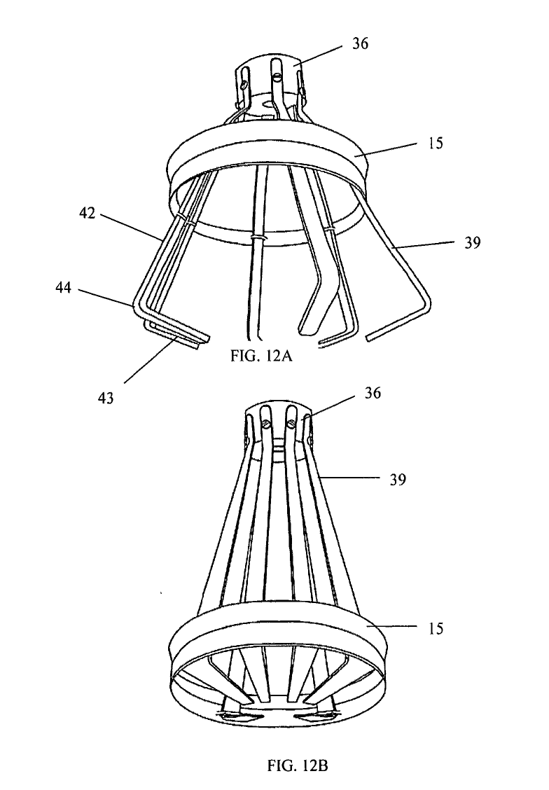

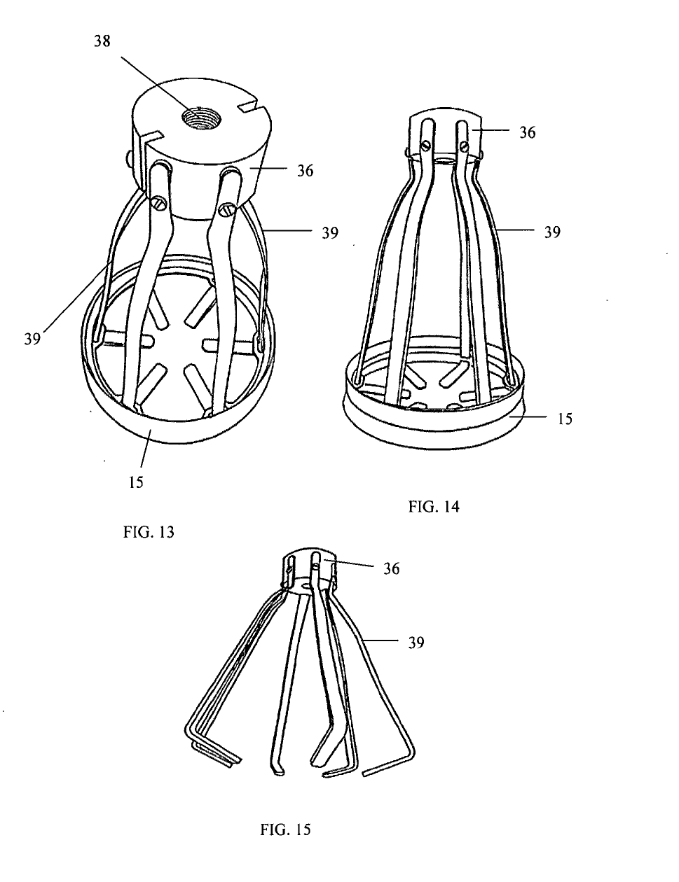

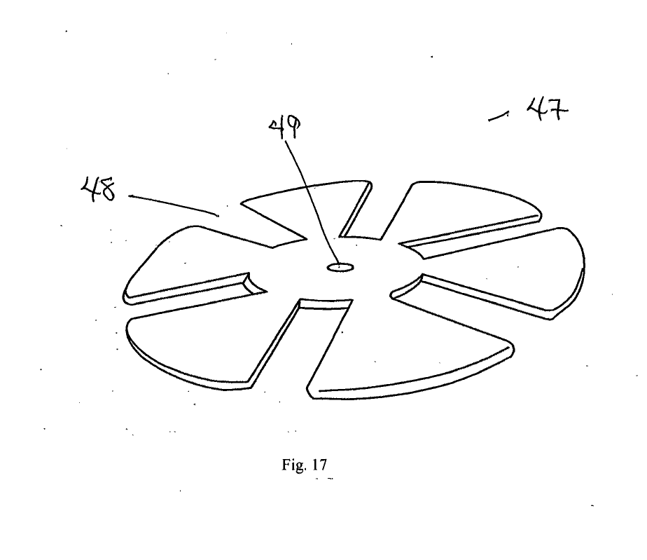

Cylindrical supporting base 15 may be optionally assembled to the main body 11 at the blower section 14 and it comprises an external surface 16, an internal surface 17 and an internal flange 18. Furthermore, it also comprises multiple apertures 19, located at the internal flange 18, as illustrated in details in FIGS. 16A and 16B, wherein views of the supporting base are shown in different perspectives. Apertures 19 provide an inserting slot wherein each one of the grasping elements 39 is inserted and from wherein said grasping elements 39 may be smoothly slid. FIGS. 12A, 12B, 13 and 14 also illustrated different views of the cylindrical base 15 already inserted in the grasping elements 39 and previous to be attached it to housing 11. The embodiments 10 and 50 may be used with or without supporting base 15.

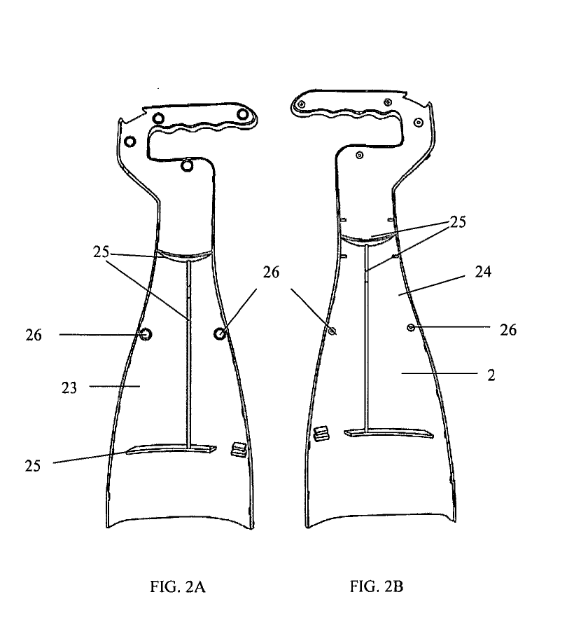

FIG. 1A shows embodiment 10 wherein the grasping elements 39 are inside the interior cavity 21 of the device 10, meaning that said grasping elements 39 in a close position, while in FIG. 1B, said grasping elements 39 are outside of the internal cavity 21 meaning that said elements are in an open position. The embodiment 10 may optionally have a light fixture 22 useful when walking a pet during night or in dark areas. The housing 11 of the embodiment 10 may be manufactured in one or more parts. Said housing 11 may be constructed of a light but strong plastic material, preferably biocompatible, with a thin external surface. However, it is preferred to manufacture it from two main parts that represent the halves of said housing, as if divided transversally and vertically as illustrated in FIGS. 2A and 2B. As illustrated in FIGS. 2A and 2B, the housing units 23 and 24 comprising internal flanges 25 and protrude elements 26 at its interior surface, which are intended to mutually match or cooperatively joined in order to close housing units 23 and 24, thus providing housing 11 with internal cavity 21, wherein the internal parts of the device are stored and organized. The entire housing 11 then may be formed by attaching or fastening said halves by means already known in the art, thus facilitating the process of assembling and fitting the internal components of the device in the interior cavity of said housing and also facilitating the subsequence maintenance activities of the devices such as cleaning and its potential repair.

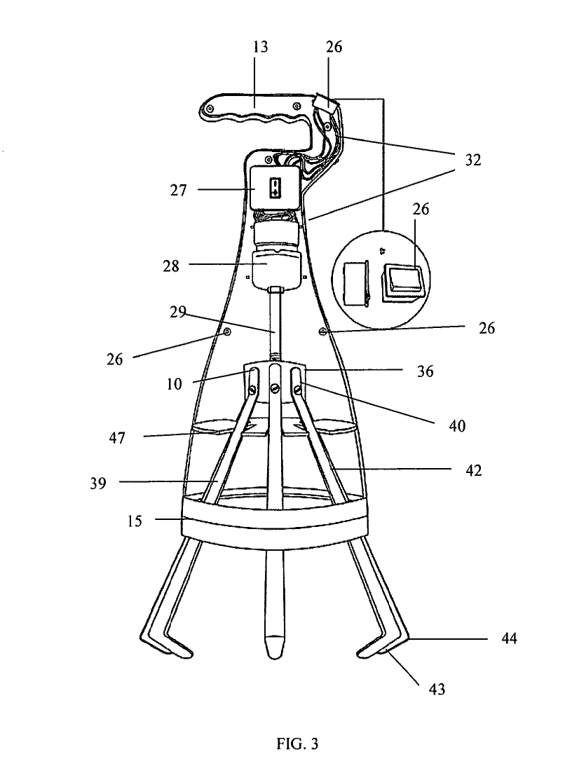

Said internal parts are illustrated in FIG. 3, wherein embodiment 10 is illustrated without the external housing units 23 and 24 in order to show the internal parts of the device and the manner such parts are organized and connected. As illustrated in FIG. 3, inside the internal cavity 21 of its housing 11, the device contains a series of components that conforms the collection mechanism. Particularly, it comprises a dual control switch 26, a rechargeable battery 27, an electric motor 28, a worm gear 29 and a grasping system 30. Regarding dual switch 26, a prototype of it is illustrated in FIG. 3. It comprises at least positions to control the worm gear 29 in order to stop it, move it up or move it down.

Returning to the internal assembled parts of device 10, the rechargeable battery 27 is electrically wired or electrically coupled to the electrical motor 28 and is also electrically wired to the control switch 26 by means of the electric wiring system 32. Battery 27 may be recharged by placing the device on a base connected to the mains, or directly by connecting one end of a charger to the mains and the other end to the device by means of a cable and a jack.

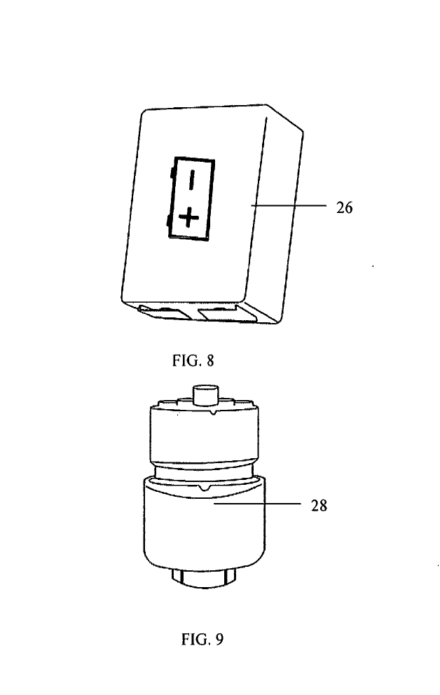

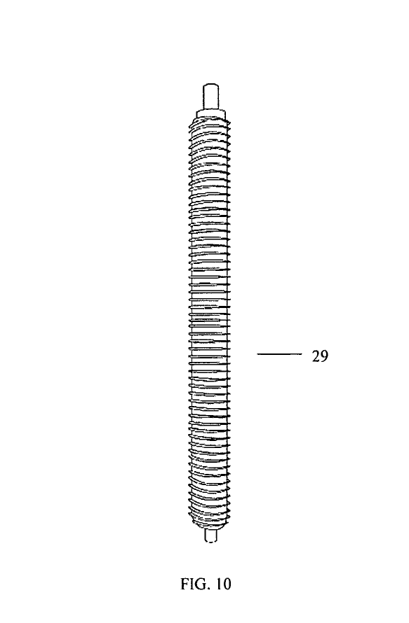

The electric motor 28 is preferably a continuos electrical current micro motor or in the alternative, a micro motor reductor. FIG. 9 illustrates a prototype of the required electrical motor 28. Conventionally, and as well known in the prior art, said motor 28 comprises at its lower side nut 33, capable of being engages a worm gear screw as 29. The rotation of the motor 28 causes the rotation of the nut 33, which also causes the screw worm gear 29 to move up or down, depending of or according to the direction in which the motor 28 turns, which depends on the position of the dual control switch 26. By such mechanism, the rotatory motion of the motor 28 is converted into linear motion of the worm gear 29. Thus, using the control switch 26, which is capable of revert the motion of the rotation of the motor 28, a method is provided in order to move up or down the worm gear 29. The term worm gear herein used comprises in practical terms a screw 34, as the one illustrated in FIG. 10.

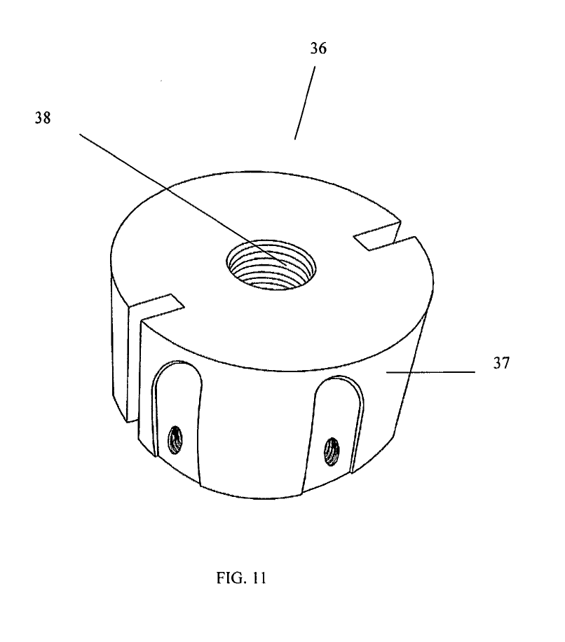

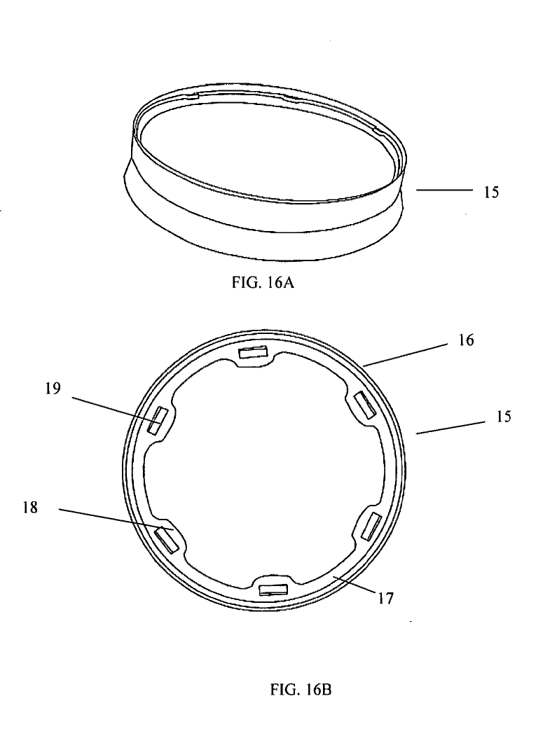

Said worm gear 29 is engaged to a grasping system 35, wherein said grasping system 35 comprises a cylindrical grasping holder 36 having a main body 37 with a threaded hole 38 at substantially its center. Details of said grasping holder 36 are illustrated in FIG. 11. The grasping system 35 also comprises multiple L-shaped flexible and hard grasping elements or collection elements 39. Said grasping units 39 simulates “claws” and comprises an upper end 40, which is fastened around the lateral walls of the cylindrical main body 37 of grasping elements holder 36. Preferably, grasping elements 39 may be fastened to holder 36 with screws as illustrated, for example in FIGS. 3, 6A, 6B, 6C, 12A, 12B, 13, 14 and 15. Furthermore, grasping elements 39 also comprises an elongated flat main body 42 and a lower end 43 having an angled or bent geometry illustrated by the angled section 44. Said grasping elements or “claws” may be made of hard and flexible material such as plastic or metal. FIG. 15 illustrates the details of the grasping system individually assembled on the grasping holder 36.

As mentioned previously, said grasping system 35 is assembled to the worm gear 29 by screwing it the worm gear 29 through the threaded hole 38 in a manner that the grasping system 35 is allowed to move up or down depending on the motion of the worm gear 29, said motion depending on the direction in which the motor 28 turns and wherein said motor's direction is controlled by the user of the device via the dual control switch witch 26. As the screw of the worm gear 29 moves up or down, the grasping system 35 also moves up or down while the screw 34 passes through the threaded hole 38 at substantially the center of said main cylindrical body 37. Thus, the movement of the worm gear 29 is transmitted to the grasping system 35 via the cylindrical body 37, thus moving the grasping elements 39 or claws inside or outside the housing 11 of the device 10 at the user's discretion.

Optionally, the embodiment 10 may also comprises a separator unit 47, which is a rounded, flat and circular unit with a multiple openings 48 and a center threaded hole 49 at its center. Said separator unit 47 may be threaded to the lower end of the worm gear via its threaded whole 49, thus maintaining the grasping elements 39 separated at a predetermined position and facilitating the displacing of said grasping elements 39 at the interior cavity 21 of the housing 11.

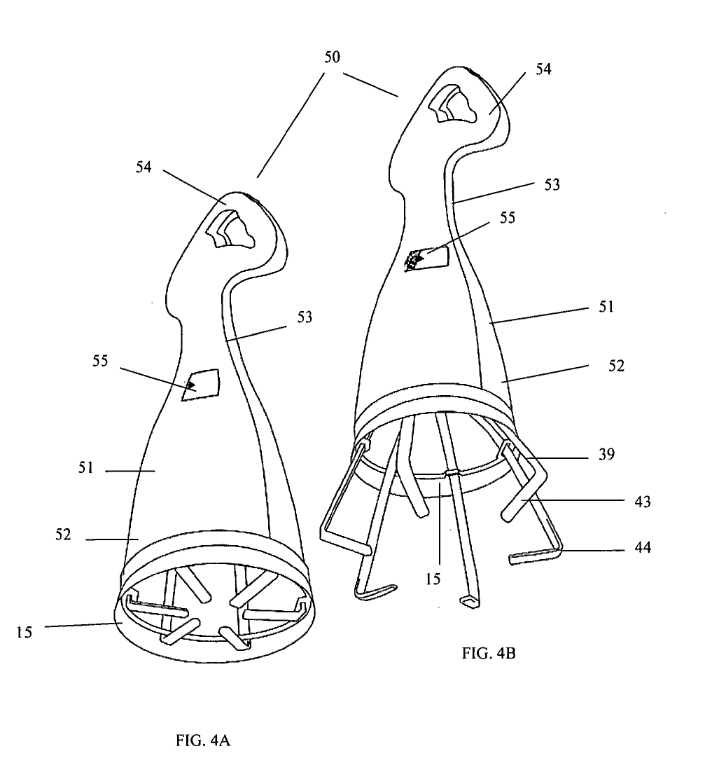

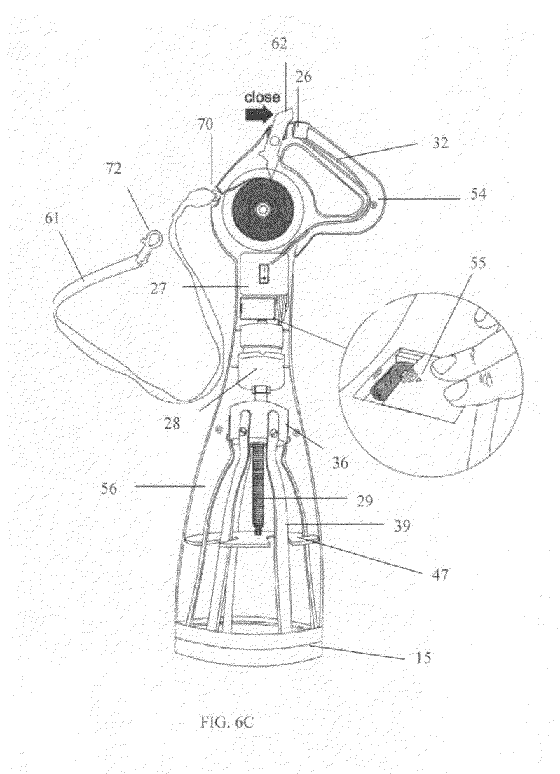

A second embodiment 50 of the invention is illustrated in FIG. 4A through FIG. 7. As illustrated in FIGS. 4A and 4B, embodiment 50 comprises main body or housing 51 having a flare lower section 52, an upper section 53 with a diameter smaller that the lower section 52, a handle 54 at the upper section of said main body 51 and a compartment 55, useful to store bags used in the collection of excrements. Optionally, housing 51 may also include a cylindrical base 15. FIG. 4A illustrates embodiment 50 having the grasping elements 39 outside of the housing 51 while FIG. 4B illustrates embodiments 50 with the grasping elements 39 outside of housing 51.

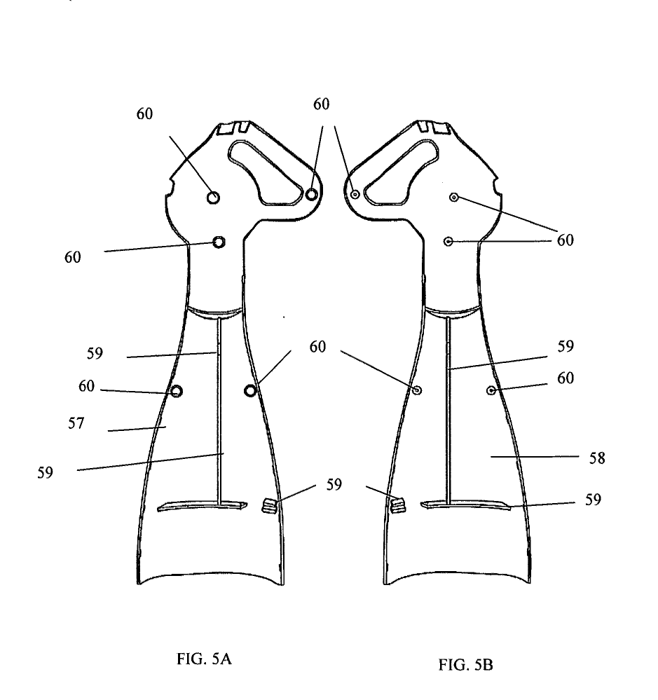

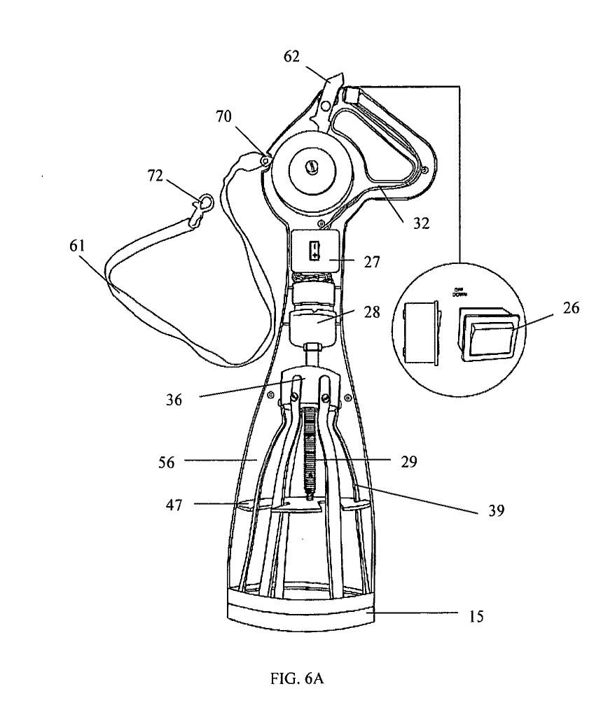

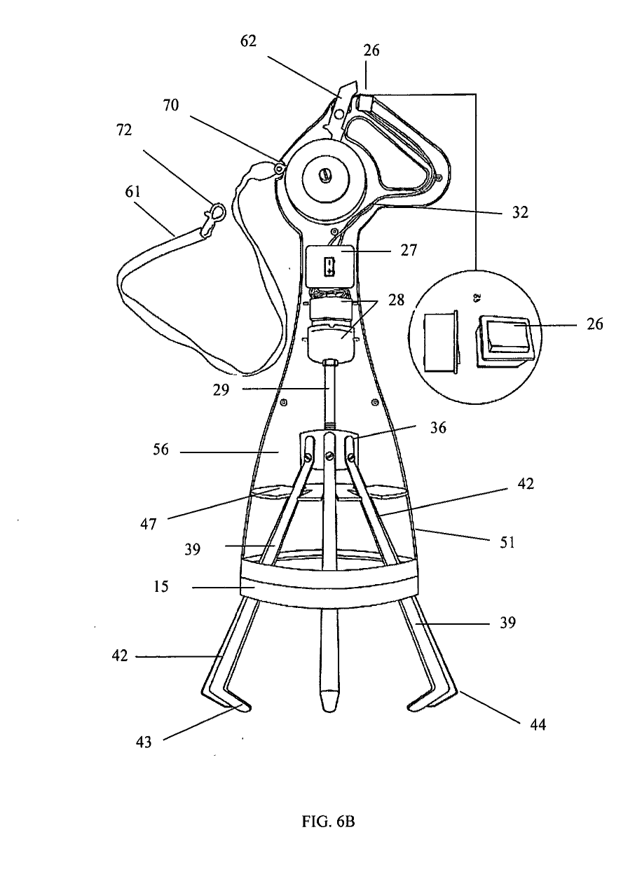

As explained previously in regards to the internal parts of embodiment 10, housing 51 may be manufactured in one or more parts. Said housing 51 may be constructed of a light but strong plastic material, preferably biocompatible, with a thin external surface. However, it is preferred to manufacture it from two main parts that represent the halves of said housing, as if divided transversally and vertically as illustrated in FIGS. 5A and 5B. As illustrated in FIGS. 5A and 5B, the housing units 57 and 58 comprising internal flanges 59 and protrude elements 60 at its interior surface, which are intended to mutually match or cooperatively joined in order to close housing units 57 and 58, thus providing housing 51 with internal cavity 56, wherein the parts of the device are stored and organized. Likewise as in embodiment 10, the entire housing 51 then may be formed by attaching or fastening said halves, thus facilitating the process of assembling and fitting the internal components of the device in the interior cavity of said housing and also facilitating the subsequence maintenance activities of the devices such as cleaning and its potential repair. Similar to the housing 11 of embodiment 10, and as illustrated in FIGS. 6A through 6C, embodiment 50 comprises in the same manner: a rechargeable battery 27 electrically wired or electrically coupled to the electrical motor 28 and electrically wired to the control switch 26 by means of the electric wiring system 32; an electric motor 28, which is preferably a continuos electric current micro motor or in the alternative, a micro motor reductor; a worm gear screw 29 engaged to the electric motor 28 and a grasping system 39 comprising a grasping elements holder 36 with a cylindrical main body having a threaded hole 38 at substantially its center and multiple L-shaped flexible and hard grasping elements or collection elements 39.

Similarly as described and explained previously for the embodiment 10, in the embodiment 50 the rotation of the motor 28 causes the rotation of the nut 33, which also causes the screw worm gear 29 to move up or down, depending of or according to the direction in which the motor turns, which depends on the position of the dual control switch 26. Therefore, using the control switch 26, which is capable of revert the motion of the rotation of the motor 28, it is provides a method of moving up or down the worm gear 28 and thus the entire grasping system 39.

As illustrated in FIGS. 6 A, 6B and 6C embodiment 50 also comprises a retractable belt or leash 61 at the upper section of the housing 51 and a leash controller unit 62, useful in extend or retract leash 61. The leash 61 has two sections; an interior section with a circular thread housed in the interior of the upper body of the collector which may be extended for several metres and goes out to the exterior through a hole 70 located in the middle of the side opposite the grip handle 54. Through the hole 70 the leash hangs from the device and is fitted with a grip snap 72 useful to attach to the animal collar.

As illustrated in FIGS. 4A, 4B and 6C, embodiment 50 may comprise compartment 55 useful for storing bags.

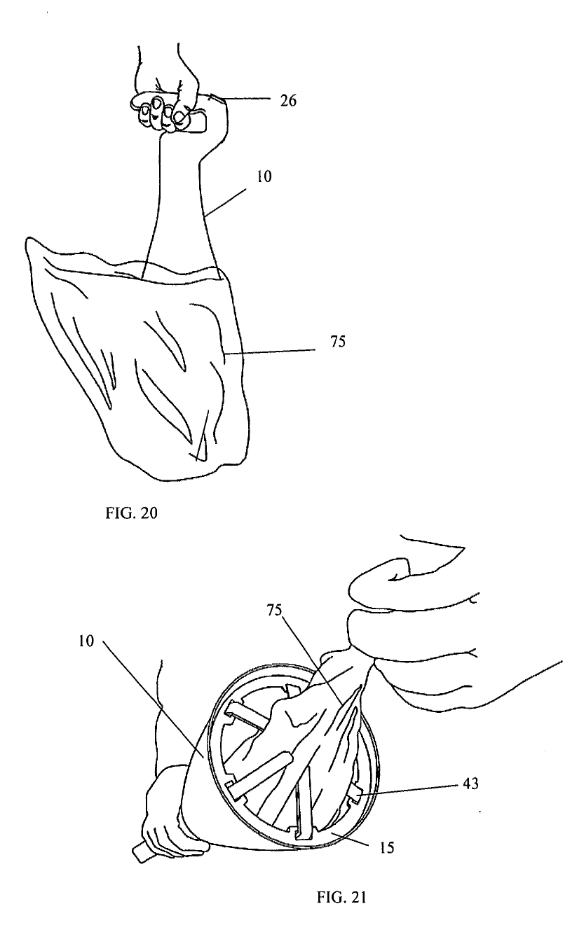

As illustrated in FIGS. 6A-6B, at the upper part of the handle 54 there is a leash control switch 62, dual switch 26 that control electric motor 28, the switch light 66 for night-time collection when light fixture 63 is optionally included. Said light 63 being useful when walking a pet or animal during the night or in dark areas.
In operational terms, FIGS. 18-21 illustrate the used of the invention. In first place, the lower section of the device is inserted in a bag 75, for instance a plastic bag, and placed at the top of the excrements 77. Preferably, said bag 75 may be made of disposable material to be used and thrown away once used.

After the activation of the control switch 26, wear worm 29 move down and as a consequence, grasping elements 39 are exposed out of the housing 11 of the device 10. The used of a plastic bag 75 with strings at the top is even more convenient, since once the excrements 77 are collected, said bag may be securely closed, thus adding even more security to the process of animal excrement's collection. Once the grasping elements 39 surrounding by the bag 75 are over the excrements 77, turning the control switch 26 to change the position of movement of the motor 24 provides moving the grasping elements 29 up in a closing configuration, thus grasping and collecting the excrements 77 and transporting them to the internal cavity 11 of the device 10. A the convenience of the user, said bag 75 may be sealed with a string and further retracted or pulled out of the device cavity at any suitable place, wherein the bag 75 and the excrements inside said bag may be properly and civically dispose without exposing the user of the device to be in physical contact with the excrements. It will not be necessary for the user to remove the bag 75 and carry it in their hand, as it will be completely sealed inside the excrement collector 10 without the risk of it falling out until it is ejected into the appropriate container by activating the container again. Embodiment 50 may be used in a practically the same illustrated manner.

What we claim is:

1. An electrically powered device useful in the collection of animal excrements, said device comprising:
an external housing, said external housing comprising:
a lower elongated bell-shaped section;
an upper section connected to said lower elongated bell-shaped section;
a handle located at the upper section;
a switch located at the upper section of the external housing;
a battery, said battery being electrically wired to said switch;
an electric motor, said electric motor being electrically wired to said battery;
a worm gear engaged to the electric motor, capable of converting the rotation motion of the electric motor into linear motion and thus allowing the worm gear to move up or down depending on the direction of the rotation of the motor;
a grasping system, said grasping system comprising:
a cylindrical main body having a threaded hole at substantially the center of said cylindrical main body and;
multiple L-shaped flexible grasping elements fastened around the lateral walls of the cylindrical main body;
wherein the grasping system is assembled to the worm gear by screwing the worm gear through the threaded hole at substantially the center of said cylindrical body, in a manner that the grasping system is allowed to move up or down depending on the motion of the worm gear, said motion depending on the direction in which the motor turns and wherein said motor direction being controlled by the user of the device via the switch.

2. The device as recited in claim 1, wherein the upper section of the housing is rounded.

3. The device as recited in claim 2, wherein the battery is rechargeable.

4. The device of claim 1, further comprising a LED light at the upper section of said housing.

5. The device as recited in claim 1, further comprising a retractable leash.

6. The device as recited in claim 1, wherein the external housing further comprises a storing bags compartment.

7. The device as recited in claim 1, wherein the grasping elements are made of metal.

8. The device as recited in claim 6, further comprising a cylindrical base engaged at the lower elongated bell-shaped section.

9. The device as recited in claim 8, wherein said cylindrical base comprises an internal flange with multiple apertures wherein the collecting elements are inserted.

10. The device as recited in claim 1, further comprising a circular separator unit having slots wherein each collecting element is inserted.

11. An electrically powered device useful in the collection of animal excrements, said device comprising:
an external housing, said external housing comprising:
a lower elongated bell-shaped section;
an upper section connected to said lower elongated bell-shaped section;
a handle located at the upper section
a cylindrical base located at the lower elongated bell-shaped section;
a switch located at the upper section of the external housing;
a battery, said battery being electrically wired to said switch;
an electric motor, said electric motor being electrically wired to said battery;
a worm gear engaged to the electric motor, capable of converting the rotation motion of the electric motor into linear motion and thus allowing the worm gear to move up or down depending on the direction of the rotation of the motor;
a grasping system, said grasping system comprising:
a cylindrical main body having a threaded hole at substantially the center of said cylindrical main body and;
multiple L-shaped flexible grasping elements fastened around the lateral walls of the cylindrical main body;
a circular separator unit having apertures and a threaded hole at substantially its center,
wherein the grasping system is assembled to the worm gear by screwing the worm gear through the threaded hole at substantially the center of said cylindrical body in a manner that the grasping system is allowed to move up or down depending on the motion of the worm gear, said motion depending on the direction in which the motor turns and wherein said motor direction being controlled by the user of the device via the switch and wherein each one of the grasping elements are located in an aperture of the circular separator in a manner that said grasping elements are easily slip up or down.
